(19) United States
(12) Patent Application Publication
(10) Pub. No.: US 2005/0112389 A1
(43) Pub. Date: May 26, 2005

(54) High temperature nanocomposite and method of making

(75) Inventors: Sergio Martins Loureiro, Saratoga Springs, NY (US); Mohan Manoharan, Niskayuna, NY (US); Randall Scott Hagerdon, North Pownal, VT (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/720,295

(22) Filed: Nov. 24, 2003

(51) Int. Cl. B32B 9/00

(52) U.S. Cl. 428/472

(57) ABSTRACT

A multiphase ceramic composite that retains nanostructural characteristics up to high temperatures. The ceramic composite comprises a mesoporous matrix and a plurality of crystalline inorganic nanoparticles, each of which having at least one dimension of less than about 100 nm, disposed throughout the mesoporous matrix. The mesoporous matrix comprises a ceramic matrix and a plurality of pores dispersed throughout the ceramic matrix and forming a mesoporous network. In one embodiment, the ceramic composite is thermally and structurally stable—i.e., it does no undergo any decomposition or melting—up to about 1000° C. Methods of making a ceramic composite and a ceramic composite article having such a mesoporous matrix are also disclosed.

### BACKGROUND OF INVENTION

The invention relates to ceramic composites. More particularly, the invention relates to a ceramic composite, having nanostructural characteristics, that is thermally and structurally stable at high temperatures. The invention also relates to a method of making such ceramic composites.

Materials having the capability to maintain adequate properties at extremely high temperatures are highly sought after for use in a variety of structural applications, such as, for example, turbine assemblies for power generation and aircraft propulsion.

Many ceramic materials easily surpass metals in certain high-temperature properties. Ceramics in general are stronger and lighter than high temperature alloys, and resistant to environmental attack and creep. However, due to their low damage tolerance, ceramic materials have seen relatively limited use in structural components applications. Because they are brittle, ceramics tend to fail with very little to no plastic deformation, and the energy required to produce a complete fracture, a quantity often referred to in the art as “toughness,” is comparatively low.

Many materials found in nature exhibit combinations of mechanical and physical properties not found in engineered materials. Some of these superior properties can be attributed to the unique combination of adhesion, architecture, and composite element interaction that leads to significant property enhancements.

The application of those principles underlying naturally occurring materials to synthetic inorganic hierarchical systems has been limited by the lack of processing methods that are capable of retaining precise structural control at multiple length scales. Ceramic composites have been traditionally made by consolidation and sintering of powders having sizes in the micrometer range. Defect control in ceramic materials is important for good mechanical performance, and the failure dependence upon scale is known.

Nanotechnology provides an ideal opportunity to expand control over multiple length scales by allowing control over structure and function at the nanoscale. Although nanosize powders of inorganic materials are readily available, they not lend themselves to the techniques of consolidation and sintering. One problem associated with incorporating nanosize powders into such prior-art methods of producing composites is the retention of the resulting nanostructure at the sintering temperature.

Currently, ceramic nanocomposites having a multiphase microstructure are beyond the reach of the current approach of consolidation and sintering. Therefore, what is needed is a ceramic nanocomposite that is capable of retaining its nanostructure at high temperatures. What is also needed is a method of making such a ceramic nanocomposite.

### BRIEF SUMMARY OF INVENTION

The present invention meets these and other needs by providing a multiphase ceramic composite that retains nanostructural characteristics up to high temperatures. The ceramic composite comprises a mesoporous matrix and a plurality of crystalline inorganic nanoparticles, each of which having at least one dimension of less than about 100 nm, disposed throughout the mesoporous matrix. The mesoporous matrix comprises a ceramic matrix and a plurality of pores dispersed throughout the ceramic matrix and forming a mesoporous network. In one embodiment, the ceramic composite is thermally and structurally stable—i.e., it does no undergo any decomposition or melting—up to about 1000° C. A method of making a ceramic composite having such a mesoporous matrix is also disclosed.

Accordingly, one aspect of the invention is to provide a ceramic composite. The ceramic composite comprises: a mesoporous matrix, the mesoporous matrix comprising a ceramic matrix and having a plurality of pores dispersed therethrough; a plurality of inorganic crystalline nanoparticles (also referred to hereinafter as “nanodispersoids”) dispersed throughout the mesoporous matrix and disposed within the plurality of pores. Each of the plurality of nanodispersoids has at least one dimension of less than about 100 nm, and the mesoporous matrix imposes a short-range ordered structure around each of the nanodispersoids.

A second aspect of the invention is to provide an array of ceramic nanoparticles templated within a mesoporous network, wherein the mesoporous network forms an ordered structure surrounding each of the ceramic nanoparticles in the array.

A third aspect of the invention is to provide a ceramic composite. The ceramic composite comprises: a mesoporous matrix comprising a ceramic matrix and having a plurality of pores dispersed therethrough, wherein the plurality of pores form a mesoporous network; and an array of ceramic nanoparticles templated within the mesoporous network. The mesoporous network forms an ordered structure around each of the ceramic nanoparticles in the array. Each of the plurality of ceramic nanoparticles has at least one dimension of less than about 100 nm, and the ceramic composite is thermally and structurally stable up to about 1000° C.

A fourth aspect of the invention is to provide a method of making a ceramic composite comprising a mesoporous matrix. The mesoporous matrix comprises a ceramic matrix and has a plurality of pores dispersed therethrough, wherein the plurality of pores form a mesoporous network, and an array of ceramic nanoparticles templated within the mesoporous network, wherein each of the plurality of ceramic nanoparticles has at least one dimension of less than about 100 nm. The array forms an ordered structure within the mesoporous network. The method comprises the steps of: providing a ceramic matrix material; forming a templated mesoporous network within the matrix material, wherein the mesoporous network has a controlled pore size; infiltrating the templated mesoporous network with an oxide precursor; and converting the oxide precursor into inorganic nanoparticles within the templated mesoporous network to form the ceramic composite.

A fifth aspect of the invention is to provide a method of making a ceramic composite article. The ceramic composite article comprises a mesoporous matrix. The mesoporous matrix comprises a ceramic matrix and has a plurality of pores dispersed therethrough, wherein the plurality of pores form a mesoporous network, and an array of ceramic nanoparticles templated within the mesoporous network, wherein each of said plurality of ceramic nanoparticles has at least one dimension of less than about 100 nm. The array forms an ordered structure within the mesoporous network. The method comprises the steps of: providing a ceramic matrix material; forming a templated mesoporous network within the matrix material, wherein the mesoporous network has a controlled pore size; infiltrating the templated mesoporous network with an oxide precursor; converting the oxide precursor into inorganic nanoparticles within the templated mesoporous network to form a ceramic composite powder; and forming the ceramic composite into a shape.

These and other aspects, advantages, and salient features of the present invention will become apparent from the following detailed description, the accompanying drawings, and the appended claims.

### BRIEF DESCRIPTION OF DRAWINGS

FIG. 1 is an x-ray diffraction (XRD) pattern obtained for hexagonal mesoporous silica (HMS) samples: (a) as-prepared; (b) following removal of surfactant; and c) calcined at 500° C. in air for 4 hours;

FIG. 2 is an energy dispersive spectrocopy (EDS) spectrum obtained for the HMS samples described in FIG. 1;

FIG. 3 is a transmission electron microscopy (TEM) image for the HMS samples described in FIG. 1;

FIG. 4 is an x-ray diffraction (XRD) pattern obtained for a HMS/HfO₂ nanocomposite sample that had been calcined at 500° C. in air for four hours;

FIG. 5 is an energy dispersive spectrocopy (EDS) spectrum obtained for the HMS/HfO₂ nanocomposite sample shown in FIG. 4;

FIG. 6 is a transmission electron microscopy (TEM) image for the HMS/HfO₂ nanocomposite sample shown in FIG. 4;

FIG. 7 is a plot of the densities of HMS and HMS/HfO₂ pellets as a function of the annealing temperature;

FIG. 8 shows XRD patterns and TEM images obtained for HMS pellets heated at: (a) 1500° C. for 8 hours; (b) 1200° C. for 7 hours; and (c) 1000° C. for 5 hours in air; and

FIG. 9 shows obtained for HMS/HfO₂ nanocomposite pellets heated at: (a) 1500° C. for 8 hours; (b) 1200° C. for 7 hours; and (c) 1000° C. for 5 hours in air.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

Referring to the drawings in general, it will be understood that the illustrations are for the purpose of describing a preferred embodiment of the invention and are not intended to limit the invention thereto.

The present invention provides a multiphase ceramic composite (also referred to hereinafter as “ceramic composite”) that retains nanostructural characteristics up to high temperatures. The ceramic composite comprises a mesoporous matrix and a plurality of crystalline inorganic nanoparticles (also referred to hereinafter as “nanodipersoids”), each of which having at least one dimension of less than about 100 nm, disposed throughout the mesoporous matrix. The mesoporous matrix comprises a ceramic matrix and a plurality of pores dispersed throughout the ceramic matrix and forming a mesoporous network. In one embodiment, the ceramic composite is thermally stable—i.e., it does not undergo any decomposition or melting—up to about 1000° C. The ceramic composite is also structurally stable up to about 1000° C.; i.e., neither the mesoporous ceramic matrix nor the nanodispersoids undergo a substantial change in crystal structure or morphology at or below this temperature.

The mesoporous matrix imposes order around the individual nanodispersoids in the ceramic composite. Depending on the constituents of the ceramic composite, long range order is imposed upon the nanodispersoids, while in other embodiments, short range order is imposed. In one embodiment, the order comprises a structure such as a bi-dimensional hexagonal structure, a lamellar structure, a cubic structure, or the like. The matrix comprises any metal oxide that can produce at least one mesoporous structure. In one embodiment, the matrix comprises at least one transition metal oxide. The transition metal oxide is thermally and structurally stable up to about 1000° C., and, preferably, is thermally and structurally stable up to about 1500° C. In one embodiment, the transition metal oxide comprises at least one of hafnia and zirconia. In another embodiment, the matrix comprises silica.

The plurality of inorganic nanoparticles form an array of templated nanoparticles within the mesoporous network. Each of the plurality of nanoparticles comprises at least one of an inorganic carbide, an inorganic nitride, boride, an inorganic oxide, and combinations thereof. Inorganic oxides silicates, borates, phosphates, aluminates, and the like. In one embodiment, the at least one inorganic oxide comprises at least one oxide of a group IVB metal. The group IVB metal oxide is preferably one of hafnia, zirconia, or combinations thereof. In another embodiment, each of the plurality of nanoparticles provides at least one inorganic host lattice to which a dopant may be added or incorporated. Dopants can be additionally incorporated or added in silica framework Non-limiting examples of such inorganic host lattices include, but not limited to, yttria, europia, ceria, yttrium silicate, gadolinium silicate, lutetium silicate (LU₂SiO₅), combinations thereof, and the like. Alternatively, the at least one inorganic host lattice may comprise at least one light activating species, wherein each light activating species has a characteristic emission spectrum. Such species include, but are not limited to, Ni²⁺, Ti³⁺, Cr³⁺, Cr⁴⁺, Mn⁵⁺, Pr³⁺, Nd³⁺, Eu³⁺, Ho³⁺, Tm³⁺, Yb³⁺, and Ce³⁺.

Each of the plurality of nanoparticles may be substantially spherical in shape. Alternatively, other morphologies such as fibers, rods, ellipsoids, and the like are possible. Each of the plurality of inorganic nanoparticles has at least one dimension that is less than about 100 nm.

The ceramic composite of the present invention may be formed into a near net shape, such as, but not limited to, flat, hemispherical, dome, cone, and other complex shapes. Alternatively, the ceramic composite may be in the form of a coating deposited on a surface of a substrate.

The present invention also provides a method of making the multiphase ceramic composite described hereinabove. The method comprises the step of first providing a ceramic matrix material formed by a templated mesoporous network. The templated mesoporous network is then infiltrated with at least one oxide precursor of the inorganic nanoparticles. Finally, the ceramic composite is formed by converting the at least one oxide precursor into nanoparticles of the corresponding inorganic oxide.

The ceramic matrix material that is provided comprises any metal oxide that can produce at least one mesoporous structure. In one embodiment, the matrix comprises at least one transition metal oxide. The transition metal oxide is thermally and structurally stable up to about 1000° C., and, preferably, is thermally and structurally stable up to about 1500° C. In one embodiment, the transition metal oxide comprises at least one of hafnia and zirconia. In another embodiment, the matrix comprises silica. A templated mesoporous network is then formed within the ceramic matrix material. In one embodiment, the templated mesoporous network is formed by a neutral templating synthesis route. Such a route is described by P. Tanev and T. Pinnavaia in Science, 267 (1995) pp. 865-867, the contents of which are incorporated herein by reference in their entirety. In one non-limiting example, hexagonal mesoporous silica (also referred to hereinafter as “HMS”) is prepared from the silica matrix material.

Using the synthetic route of Tanev et al., HMS is synthesized by first adding tetraethyl orthosilicate to a solution of a primary amine in ethanol and deionized water. In one embodiment, the primary amine comprises from about 8 to 12 carbon atoms. In one embodiment, the solution comprises about 0.27 moles dodecyl amine, about 9.09 moles ethanol, and about 29.6 moles deionized water. The reaction mixture is then aged in air at room temperature for about 18 hours, and the resulting HMS collected. The HMS template material is then mixed with ethanol, filtered, and washed with ethanol.

In one embodiment, infiltration of the inorganic oxide precursor is achieved by introducing HMS into a solution having a predetermined concentration of a precursor. Candidate precursors include, but are not limited to, at least one soluble inorganic metal salt such as chlorides and nitrates that yield an inorganic oxide. The solution is stirred for a predetermined time while maintaining the matrix/solution mixture at a predetermined temperature. For example, in order to infiltrate HMS with a hafnia (HfO₂) precursor, HMS is mixed into an aqueous solution of 1M hafnium tetrachloride (HfCl₄). The resulting mixture is then stirred while being maintained at a temperature of about 60° C., and a precipitate is formed. The resulting precipitate is then calcined at a predetermined temperature to form a nanocomposite comprising the matrix material and the inorganic oxide. A nanocomposite comprising HMS and hafnia, for example, is formed from the precipitate that is obtained from the solution described above by calcining the precipitate at a temperature in a range from about 500° C. to about 600° C. in air or oxygen for a time period ranging form about 2 to about 10 hours.

The present invention also provides a method of making a ceramic composite article formed from the multiphase ceramic composite described hereinabove. The method comprises first making the multiphase ceramic composite according to the method described hereinabove, followed by forming the resulting ceramic composite powder into a shape. The shape is formed by methods that are known in the art such as, but not limited to, cold pressing, hot pressing, hot isostatic pressing, slip casting, thermal spraying, and the like.

The following example illustrates the features and advantages offered by the present invention.

### EXAMPLE 1

Hexagonal Mesoporous Silica (HMS) was synthesized according to a neutral templating route reported by Tanev and Pinnavaia (Science, 267 (1995) pp. 865-867) and previously described herein. The HMS was divided into two portions after aging. The first portion of HMS was thoroughly washed with ethanol and calcined at 500° C. in air for 4 hours. Approximately 60 g of the second portion were mixed with 50 cm³ of 1M HfCl₄ solution and stirred for 2 hours at 60° C. The resulting precipitate, a nanocomposite comprising HMS and hafnia (HfO₂), was washed with distilled water and calcined at 500° C. in air for 4 hours.

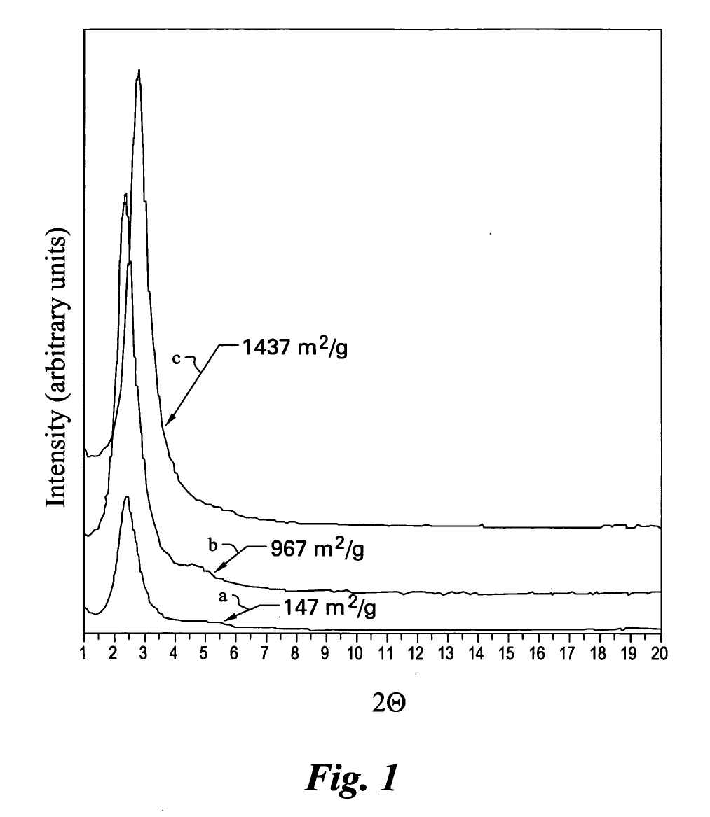

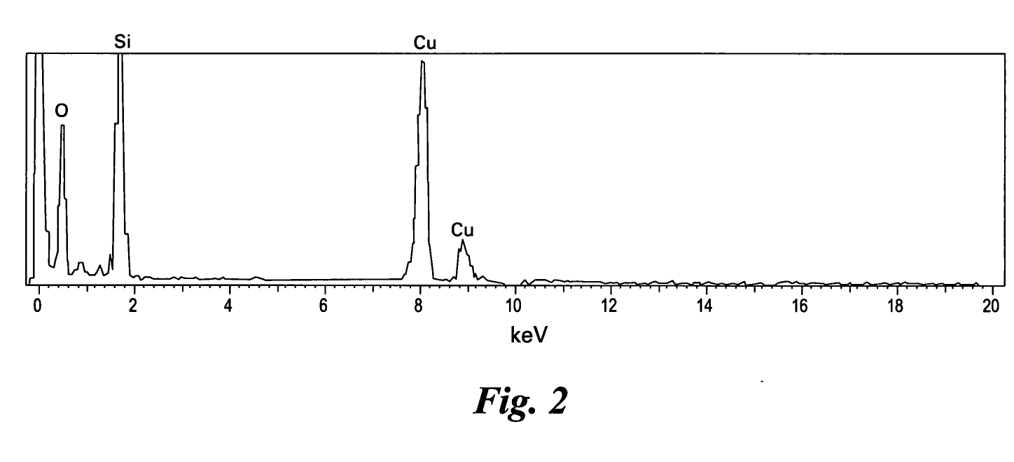

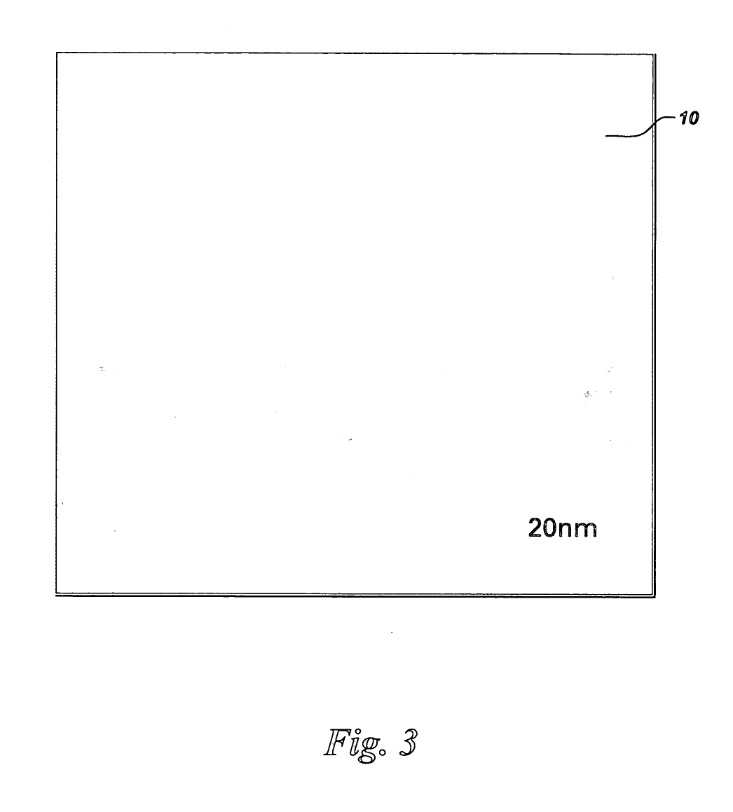

The x-ray diffraction (XRD), transmission electron microscopy (TEM) images, and energy dispersive spectroscopy (EDS) data for HMS and the HMS/HfO₂ nanocomposite, are shown in FIGS. 1-3 and 4-6, respectively. The parent HMS material (FIGS. 1-3) is fairly disordered, which is typical of mesoporous silica prepared through a neutral amine route. The XRD pattern in FIG. 1 shows the characteristic hexagonal (100) reflection exhibited by such hexagonal mesoporous materials. The surface areas (measured by the BET (Brunauer-Emmett-Teller) method) of the starting material (‘a’ in FIG. 1), a material in which the surfactant was removed by washing with ethanol (‘b’ in FIG. 1), and the calcined material (‘c’ in FIG. 1) agree with those previously reported by Tanev and Pinnavaia. EDS analysis (FIG. 2) shows that the material is constituted only by silicon and oxygen. The copper peaks appearing in the EDS spectrum are attributed to the type of grid used in the measurement.

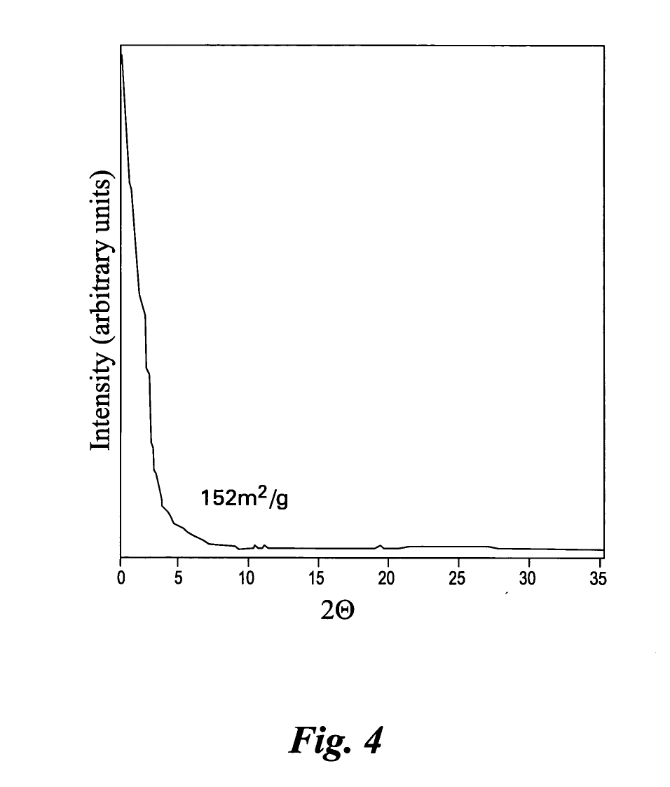

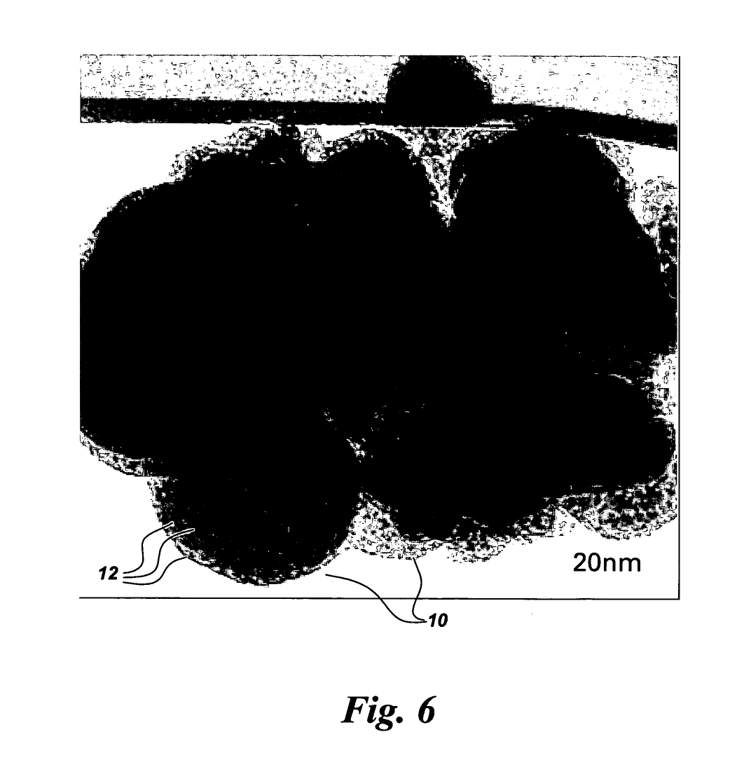

The XRD data (FIG. 4) obtained for the HMS/HfO₂ nanocomposite show that the (100) hexagonal peak, although present, appears at a lower angle (2θ˜1°) than in the HMS parent material, which indicates that the HMS/HfO₂ composite has a more disordered structure than the HMS material. The TEM image (FIG. 6) shows a silica based matrix 10, or nanostructure, in which HfO₂ nanoparticles 12 have infiltrated into the mesoporosity. The HfO₂ nanoparticles 12 are well dispersed throughout all of the HMS grains that are visible in FIG. 6. The grains are distinct bi-dimensional platelets with having an average diameter of about 50 nm. The calcined material has a BET surface area of 153 m²/g, which is considerably less than that of the calcined HMS material 1437 m²/g, indicating that HfO₂ nanoparticles 12 occupy the porosity within the HMS matrix material 10.

### EXAMPLE 2

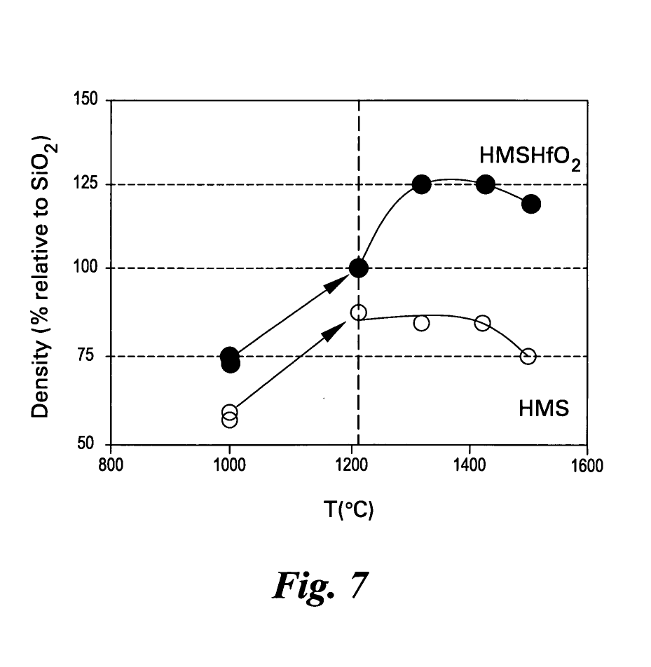

Individual pellets of HMS powder and HMS/HfO₂ composite powder were formed by first pressing each pellet under a pressure of 1 ton, followed by isostatically pressing at 43,000 psi. The pressing operation yielded uniform, white pellets which were then annealed in air at a temperature in a range from about 1000° C. to about 1500° C. for times ranging from about 1 hour to about 10 hours. The resulting sintered pellets were then characterized by geometric density measurements, X-ray powder diffraction, transmission electron microscopy, and BET surface area measurements. After furnace cooling, none of the pellets showed visible cracks, but displayed noticeable density changes. The densities of both HMS, and HMS/HfO₂ pellets relative to a standard SiO₂ density of 2.2 g/cm³, are plotted as a function of the annealing temperature in FIG. 7. The data show that the porous nature of both materials is retained up to temperatures as high as 1000° C., at which point the densities of HMS, and HMS/HfO₂ have values of about 60% and about 75%, respectively. The HMS and HMS/HfO₂ pellets exhibit similar behavior up to about 1215° C. Between 1215° C. and 1400° C., the HMS/HfO₂ nano-composite density continues to increase while the density of HMS material stabilizes. Both densities decrease at temperatures greater than 1400° C.

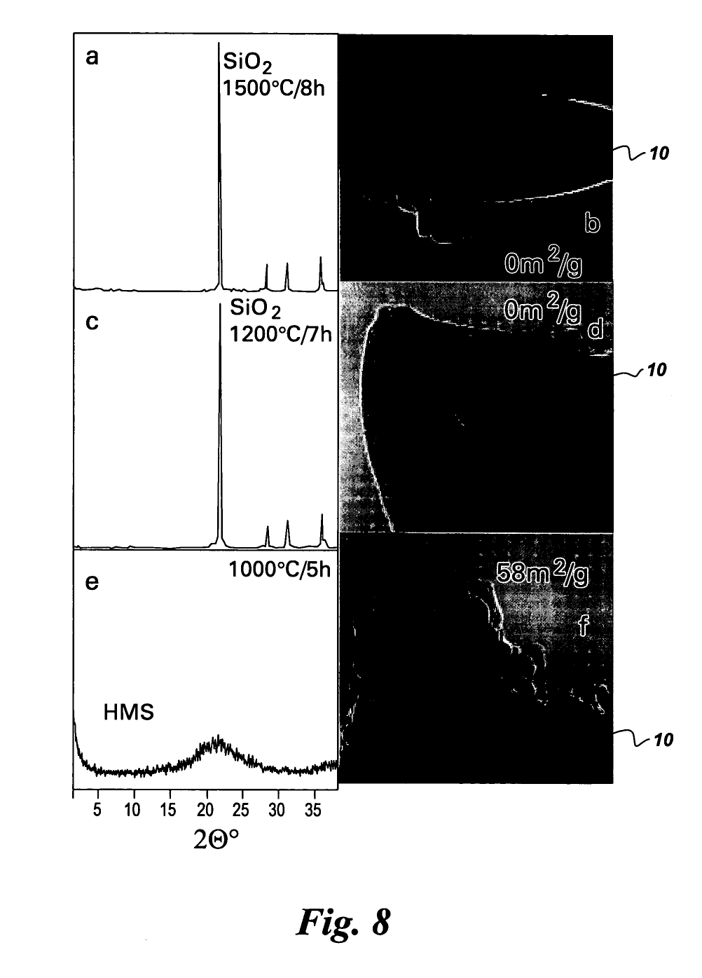

FIG. 8 shows x-ray diffraction data and TEM images for HMS control pellets heated at 1500° C. for 8 hours (FIGS. 8a, 8b), 1215° C. for 7 hours (FIGS. 8c, 8d), and 1000° C. for 5 hours (FIGS. 8e, 8f). The XRD pattern of the pellet annealed at 1000° C. for 5 hours (FIG. 8e) shows a low intensity/low angle (100) hexagonal peak, but no crystallized crystoballite peaks. The broad peak observed at 2θ˜22.5° may be attributed to the presence of either amorphous silica or a low order transitional phase between the hexagonal mesoporous silica phase and crystallized crystoballite phase. The TEM image of the same pellet (FIG. 8f) is consistent with the XRD data; the image shows a substantially dense body with some remaining porosity, but no defined structural features. The HMS pellet heated at 1000° C. has a BET surface area of 58 m²/g. This relatively low BET surface area is due to the natural densification of the material with temperature. When the temperature is increased to 1215° C. for 7 h, the XRD pattern (FIG. 8c) shows the presence of crystallized crystoballite. Due to full densification of the pellet, the BET surface area for this HMS pellet is below detection limits of the instrumentation used for the measurements. The crystal phase (FIG. 8a) and micro-structural characteristics (FIG. 8b) of the HMS pellet heated at 1500° C. appear to be unchanged from those observed at 1215° C. However, the density of the HMS pellet heated at 1500° C. decreases nearly 10% from that of the pellet heated at 1215° C. This result can probably be attributed to partial evaporation of some material from the sample heated to the higher temperature.

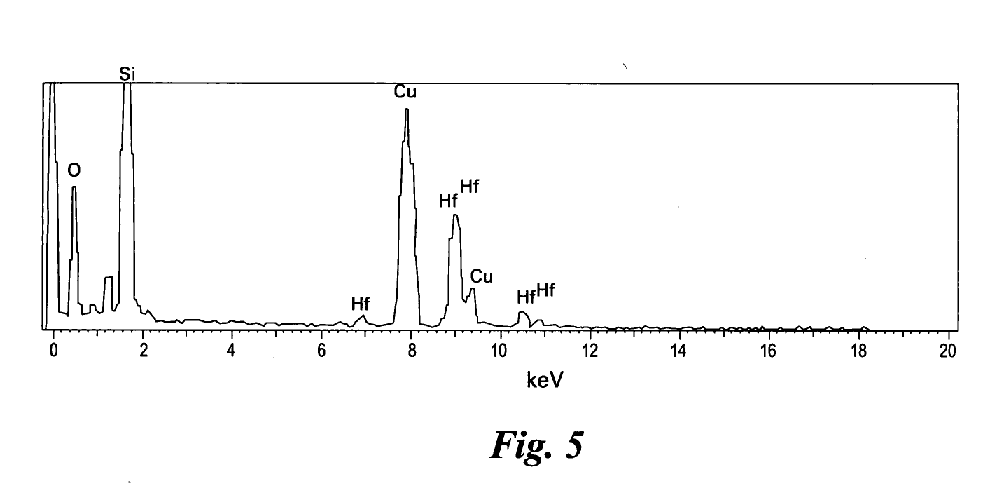

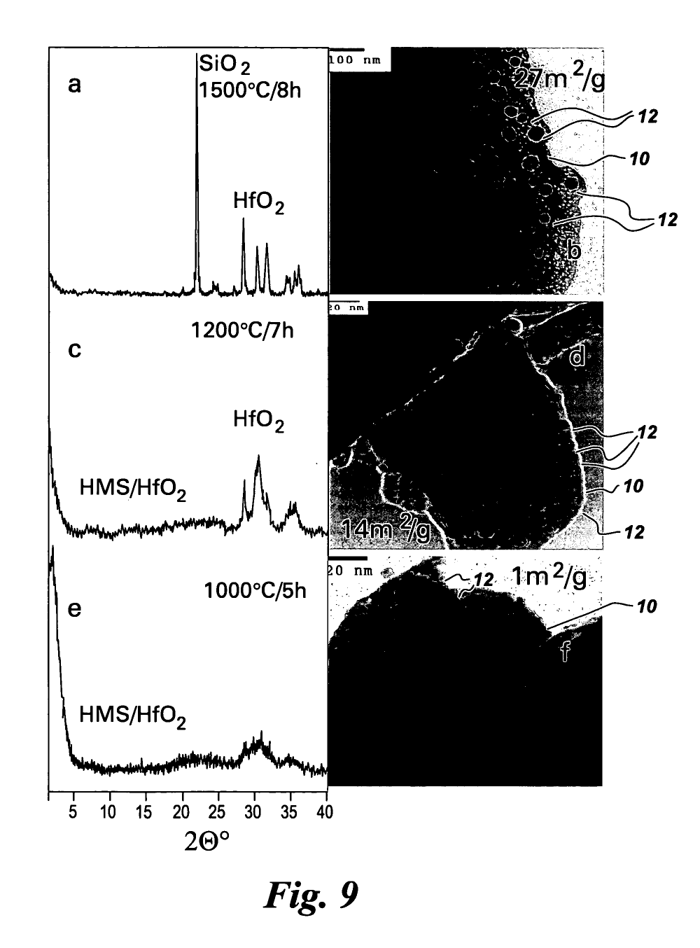

FIG. 9 shows x-ray diffraction data (XRD) and TEM images obtained for HMS/HfO₂ nanocomposite pellets heated at 1500° C. for 8 hours (FIGS. 9a, 9b), 1215° C. for 7 hours (FIGS. 9c, 9d), and 1000° C. for 5 hours (FIGS. 9e, 9f). At 1000° C., the XRD pattern (FIG. 9e) displays a clear hexagonal peak at very low angle of 2θ˜1.5°, indicating that heating at 1000° C. promoted ordering in the hafnia-filled hexagonal mesostructure, whereas the hexagonal peak was not visible in the HMS/HfO₂ material that was heated at 500° C. Crystalline crystoballite peaks are not detected in the sample heated at 1000° C., but a very broad peak with 2θ˜30° appears in the pattern shown in FIG. 5a. The TEM (FIG. 9f) shows a homogeneous microstructure in which hafnia 12 is fully dispersed within the pores of the silica mesostructure 10. The BET surface area of about 1 m²/g is, as expected, much lower than that of the HMS control material, as the HfO₂ nanoparticles occupy the pores within the silica mesostructure. At 1215° C., the intensity of the hexagonal peak observed in the XRD pattern (FIG. 9c) decreases and shifts to lower 20 values. At the same time, peaks near 2θ˜30° are clearly defined, indicating that hafnia-based nanoparticles have started to develop. However, in contrast to the HMS control pellets calcined at the same temperature, crystalline crystoballite peaks are not observed in the XRD pattern shown in FIG. 5c. The TEM image (FIG. 9d) shows a very low order mesoporous structure in which hafnia nanodispersoids 12, each having a diameter of about 20 nm, are homogeneously dispersed throughout the HMS structure 10, confirming that a high-temperature nano-composite was indeed obtained. For HMS/HfO₂ pellet that was heated at 1500° C., the XRD pattern (FIG. 9a) shows that the peak assigned to the hexagonal mesoporous structure has almost disappeared, whereas both crystalline crystoballite and crystallized hafnia peaks are present. The TEM image (FIG. 9b) shows that hafnia continues to segregate out of the mesoporosity and promotes the controlled growth of the nano-dispersoids. In addition, the BET surface area HMS/HfO₂ pellet that was heated at 1500° C. is almost double that of the HMS/HfO₂ pellet that was heated at 1215° C. The TEM image (FIG. 9b) of the pellet that was heated at 1500° C. shows visible reticular porosity resulting from evaporation of SiO₂. The increased porosity accounts for the lower density of the samples that were heated to 1500° C.

The examples described hereinabove show that a high temperature ceramic composite has been synthesized with accurate size control of the nano-dispersoid within a templated matrix. The examples have also demonstrated the ability to functionalize internal porosity at the nanoscale level.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A ceramic composite, said ceramic composite comprising:
a) a mesoporous matrix, said mesoporous matrix comprising a ceramic matrix and having a plurality of pores dispersed therethrough;
b) a plurality of inorganic crystalline nanodispersoids dispersed throughout said mesoporous matrix and disposed within said plurality of pores, wherein each of said plurality of nanodispersoids has at least one dimension of less than about 100 nm, wherein said mesoporous matrix imposes an ordered structure around each of said nanodispersoids.

2. The ceramic composite according to claim 1, wherein said ceramic composite is both thermally and structurally stable up to about 1000° C.

3. The ceramic composite according to claim 2, wherein said ceramic composite is both thermally and structurally stable up to about 1500° C.

4. The ceramic composite according to claim 1, wherein said matrix comprises at least one transition metal oxide.

5. The ceramic composite according to claim 4, wherein said transition metal oxide is one of hafnia and zirconia.

6. The ceramic composite according to claim 4, wherein said transition metal oxide is stable up to about 1000° C.

7. The ceramic composite according to claim 4, wherein said transition metal oxide is stable up to about 1500° C.

8. The ceramic composite according to claim 1, wherein said matrix comprises silica.

9. The ceramic composite according to claim 1, wherein said plurality of nanoparticles comprises at least one inorganic oxide.

10. The ceramic composite according to claim 9, wherein said at least one inorganic oxide comprises at least one group IVB metal oxide.

11. The ceramic composite according to claim 10, wherein said at least one group IVB metal oxide is one of hafnia, zirconia, and combinations thereof.

12. The ceramic composite according to claim 9, further comprising at least one inorganic host lattice disposed in each of said plurality of nanoparticles.

13. The ceramic composite according to claim 12, wherein said inorganic host lattice comprises at least one light activating species, wherein said at least one light activating species has a characteristic emission spectra.

14. The ceramic composite according to claim 12, wherein said at least one light activating species comprises at least one of Ni²⁺, Ti³⁺, Cr³⁺, Cr⁴⁺, Mn⁵⁺, Pr³⁺, Nd³⁺, Eu³⁺, Ho³⁺, Tm³⁺, Yb³⁺, and Ce³⁺.

15. The ceramic composite according to claim 12, wherein said inorganic host lattice comprises at least one of yttria, europia, ceria, yttrium silicate, gadolinium silicate, lutetium silicate, and combinations thereof.

16. The ceramic composite according to claim 1, wherein said ordered structure is a bidimensional hexagonal structure.

17. The ceramic composite according to claim 1, wherein said ordered structure is a cubic structure.

18. The ceramic composite according to claim 1, wherein said ordered structure is a lamellar structure.

19. An array of ceramic nanoparticles templated within a mesoporous network, wherein said mesoporous network forms an ordered structure surrounding each of said ceramic nanoparticles in said array.

20. The array according to claim 19, wherein said ordered structure is a bidimensional hexagonal structure.

21. The array according to claim 19, wherein said ordered structure is a cubic structure.

22. The array according to claim 19, wherein said ordered structure is a lamellar structure.

23. The array according to claim 19, wherein said each of said nanoparticles comprises at least one inorganic oxide.

24. The array according to claim 23, wherein said at least one inorganic oxide comprises at least one group IVB metal oxide.

25. The array according to claim 24, wherein said at least one group IVB metal oxide is one of hafnia and zirconia.

26. The array according to claim 24, further comprising at least one inorganic host lattice disposed in each of said plurality of nanoparticles.

27. The array according to claim 26, wherein said inorganic host lattice comprises at least one light activating species, wherein said at least one light activating species has a characteristic emission spectra.

28. The array according to claim 26, wherein said at least one light activating species comprises at least one of Ni²⁺, Ti³⁺, Cr³⁺, Cr⁴⁺, Mn⁵⁺, Pr³⁺, Nd³⁺, Eu³⁺, Ho³⁺, Tm³⁺, Yb³⁺, and Ce³⁺.

29. The array according to claim 26, wherein said inorganic host lattice comprises at least one of yttria, europia, ceria, yttrium silicate, gadolinium silicate, lutetium silicate, and combinations thereof.

30. A ceramic composite, said ceramic composite comprising:
a) a mesoporous matrix, said mesoporous matrix comprising a ceramic matrix and having a plurality of pores dispersed therethrough, wherein said plurality of pores form a mesoporous network; and
b) an array of ceramic nanoparticles templated within said mesoporous network, wherein said mesoporous network forms an ordered structure around each of said ceramic nanoparticles in said array, wherein each of said plurality of ceramic nanoparticles has a dimension of less than about 100 nm, wherein said ceramic composite is thermally and structurally stable up to about 1000° C.

31. The ceramic composite according to claim 30, wherein said ceramic composite is both thermally and structurally stable up to about 1500° C.

32. The ceramic composite according to claim 30, wherein said matrix comprises at least one transition metal oxide.

33. The ceramic composite according to claim 30, wherein said transition metal oxide is one of hafnia and zirconia.

34. The ceramic composite according to claim 30, wherein said matrix comprises silica.

35. The ceramic composite according to claim 30, wherein said plurality of nanoparticles comprises at least one inorganic oxide.

36. The ceramic composite according to claim 35, wherein said at least one inorganic oxide comprises at least one group IVB metal oxide.

37. The ceramic composite according to claim 36, wherein said at least one group IVB metal oxide is one of hafnia and zirconia.

38. The ceramic composite according to claim 35, further comprising at least one inorganic host lattice disposed in each of said plurality of nanoparticles.

39. The ceramic composite according to claim 38, wherein said inorganic host lattice comprises at least one light activating species, wherein said at least one light activating species has a characteristic emission spectra.

40. The array according to claim 39, wherein said at least one light activating species comprises at least one of Ni²⁺, Ti³⁺, Cr³⁺, Cr⁴⁺, Mn⁵⁺, Pr³⁺, Nd³⁺, Eu³⁺, Ho³⁺, Tm³⁺, Yb³⁺, and Ce³⁺.

41. The ceramic composite according to claim 38, wherein said inorganic host lattice comprises at least one of one of yttria, europia, ceria, yttrium silicate, gadolinium silicate, lutetium silicate, and combinations thereof.

42. The ceramic composite according to claim 30, wherein said ordered structure is a bidimensional hexagonal structure.

43. The ceramic composite according to claim 30, wherein said ordered structure is a cubic structure.

44. The ceramic composite according to claim 30, wherein said ordered structure is a lamellar structure.

45. The ceramic composite according to claim 30, wherein said ceramic composite is formed into a near net shape.

46. The ceramic composite according to claim 30, wherein said ceramic composite is a coating disposed on a surface of a substrate.

47. A method of making a ceramic composite comprising a mesoporous matrix, the mesoporous matrix comprising a ceramic matrix and having a plurality of pores dispersed therethrough, wherein the plurality of pores form a mesoporous network, and an array of ceramic nanoparticles templated within the mesoporous network, wherein the array forms an ordered structure within the mesoporous network, and wherein each of said plurality of ceramic nanoparticles has at least one dimension of less than about 100 nm, the method comprising the steps of:
a) providing a ceramic matrix material;
b) forming a templated mesoporous network within the matrix material, wherein the mesoporous network has a controlled pore size;
c) infiltrating the templated mesoporous network with an oxide precursor; and
d) converting the oxide precursor into inorganic nanoparticles within the templated mesoporous network to form the ceramic composite.

48. The method according to claim 47, wherein the step of forming a templated mesoporous network within the matrix material comprises:
a) providing an organic silicate;
b) forming a mixture comprising the organic silicate and an aqueous solution, the aqueous solution comprising at least one primary amine, an alcohol;
c) aging the mixture for a predetermined time to form a mesoporous silica; and
d) drying the mesoporous silica to form the templated mesoporous network.

49. The method according to claim 47, wherein the step of infiltrating the templated mesoporous network with an oxide precursor comprises:
a) providing a solution, wherein the solution comprises a predetermined concentration of the oxide precursor;
b) introducing the templated mesoporous network into the solution to form a mixture; and
c) forming a precipitate comprising the templated mesoporous network infiltrated with the oxide precursor.

50. The method according to claim 47, wherein the step of converting the oxide precursor into inorganic nanoparticles within the templated mesoporous network comprises calcining the oxide precursor and the templated mesoporous network.

51. The method according to claim 47, wherein the step of calcining the oxide precursor and the templated mesoporous network comprises heating the oxide precursor and the templated mesoporous network to a temperature in a range from about 500° C. to about 600° C. in one of air and oxygen.

52. The method according to claim 47, wherein the ceramic matrix material comprises at least one of a group IVB metal oxide, silica, and combinations thereof.

53. The method according to claim 47, wherein the oxide precursor comprises at least one soluble inorganic metal salt.

54. A method of making a ceramic composite article, the ceramic composite article comprising a mesoporous matrix, the mesoporous matrix comprising a ceramic matrix and having a plurality of pores dispersed therethrough, wherein the plurality of pores form a mesoporous network, and an array of ceramic nanoparticles templated within the mesoporous network, wherein the array forms an ordered structure within the mesoporous network, and wherein each of said plurality of ceramic nanoparticles has a diameter of less than about 100 nm, the method comprising the steps of:
a) providing a ceramic matrix material;
b) forming a templated mesoporous network within the matrix material, wherein the mesoporous network has a controlled pore size;
c) infiltrating the templated mesoporous network with an oxide precursor;
d) converting the oxide precursor into inorganic nanoparticles within the templated mesoporous network to form a ceramic composite powder; and
e) forming the ceramic composite into the ceramic composite article.

55. The method according to claim 54, wherein the step of forming a templated mesoporous network within the matrix material comprises:
a) providing an organic silicate;
b) forming a mixture comprising the organic silicate and an aqueous solution, the aqueous solution comprising at least one primary amine, an alcohol;
c) aging the mixture for a predetermined time to form a mesoporous silica; and
d) drying the mesoporous silica to form the templated mesoporous network.

56. The method according to claim 54, wherein the step of infiltrating the templated mesoporous network with an oxide precursor comprises:
a) providing a solution, wherein the solution comprises a predetermined concentration of the oxide precursor;
b) introducing the templated mesoporous network into the solution to form a mixture; and
c) forming a precipitate comprising the templated mesoporous network infiltrated with the oxide precursor.

57. The method according to claim 54, wherein the step of converting the oxide precursor into inorganic nanoparticles within the templated mesoporous network comprises calcining the oxide precursor and the templated mesoporous network.

58. The method according to claim 57, wherein the step of calcining the oxide precursor and the templated mesoporous network comprises heating the oxide precursor and the templated mesoporous network to a temperature in a range from about 500° C. to about 600° C. in one of air and oxygen.

59. The method according to claim 57, wherein the ceramic matrix material comprises at least one of a group IVB metal oxide, silica, and combinations thereof.

60. The method according to claim 54, wherein the oxide precursor comprises at least one soluble inorganic metal salt.

61. The method according to claim 54, wherein the step of forming the ceramic composite into the ceramic composite article comprises at least one of cold pressing the ceramic composite, hot pressing the ceramic composite, isostatically pressing the ceramic composite, slip casting the ceramic composite, and spraying the ceramic composite to form the ceramic article.
